(19) United States
(12) Patent Application Publication
(10) Pub. No.: US 2018/0345517 A1
(43) Pub. Date: Dec. 6, 2018

(54) APPARATUS FOR MANUFACTURING PANELS MADE OF FOAMED PLASTIC MATERIAL

(71) Applicant: OMS AUTOMATION S.R.L., Verano Brianza (IT)

(72) Inventors: Luciano BOSCARI, Selvazzano Dentro (IT); Maurizio PARLATO, Isola Vicentina (IT)

(21) Appl. No.: 15/777,827

(22) PCT Filed: Nov. 21, 2016
(86) PCT No.: PCT/EP2016/078296

§ 371 Date: May 21, 2018

(30) Foreign Application Priority Data
Nov. 27, 2015 (IT) 102015000077563

(51) Int. Cl. B26D 1/553; B26D 1/50; B26D 3/00; B26D 3/06; B26D 7/18; B26D 9/00

(52) U.S. Cl. CPC B26D 1/5535; B26D 1/505; B26D 9/00; B26D 3/065; B26D 7/1863; B26D 3/006

(57) ABSTRACT

An apparatus for manufacturing panels made of foamed plastic material includes a supporting framework for a device for feeding a plate-like element to be cut to at least one cutting station and a device for unloading the plate-like element cut into panels from the cutting station. The cutting station includes a supporting structure for at least one cutting wire that forms, along its own extension, a cutting portion designed to contact the plate-like element to be cut, a component for the relative motion of the cutting portion with respect to the plate-like element to be cut, there being also, upstream of each cutting station, an incision station having at least one first incision blade adapted to provide, at at least one face of the plate-like element to be cut, a respective incision at the region designed to be contacted by the cutting portion of the cutting wire.

### TECHNICAL FIELD

The present disclosure relates to an apparatus for manufacturing panels made of foamed plastic material.

### BACKGROUND

Conventional apparatuses for manufacturing panels made of foamed material have, in sequence, a foaming station, a station for forming a continuous sheet-like element, a station for the transverse cutting of the continuous sheet-like element in order to provide panels having an elongated shape, and a station for cooling the elongated panels.

Downstream of the cooling station there is usually a redirection device for feeding the elongated panels to a transverse cutting device designed to cut the elongated panels along a direction that is transverse with respect to its own longitudinal extension in order to provide sheet-like elements having preset dimensions.

Downstream of the transverse cutting device there is a station for unloading and packaging the resulting sheet-like elements.

Normally, the transverse cutting device is constituted by a multiblade cutting unit that allows to obtain a plurality of panels having the chosen dimensions.

During the cutting step, at the multiblade cutting unit, a removal of material occurs which is equal to the sum of the thicknesses of the blades assigned to cutting: typically, the thickness of the blades used for cutting is equal to approximately 4-5 mm.

Very often the panels in output from the multiblade cutting unit are sent to a transverse squaring unit, which is adapted to provide the transverse profile shaping of the individual panels that arrive from the multiblade cutting unit.

The transverse squaring unit is assigned to removing portions of the edges of the panels in order to provide typically male/female profiles: this operation causes a further removal of material comprised between 2 mm and 5 mm from each side of the panel.

For this reason, it is noted that for each panel to be manufactured it is necessary to provide an excess of material equal to the thickness of the male or female part (10-20 mm), the thickness for the squaring errors (4-10 mm), in addition to half of the thickness of the blade, for a total that can vary between 15 mm and 30 mm of removed material.

It is therefore evident that as the panels to be obtained increase, the material to be removed increases considerably, with a consequent increase in production costs and in costs for disposal of the removed material.

### SUMMARY

The aim of the present disclosure is to provide an apparatus for manufacturing panels made of foamed plastic material that allows to eliminate or at least reduce drastically the drawbacks noted above.

Within this aim, the present disclosure provides an apparatus for manufacturing panels made of foamed plastic material that allows to save significantly on raw material with respect to traditional devices.

The disclosure also provides an apparatus for manufacturing panels made of foamed plastic material that is extremely compact and easy to manage.

The present disclosure further provides an apparatus that allows an increase in productivity and at the same time higher reliability.

These advantages that will become better apparent hereinafter, are achieved by providing an apparatus for manufacturing panels made of foamed plastic material according to the provisions of the independent claims that follow.

### BRIEF DESCRIPTION OF THE DRAWINGS

Further characteristics and advantages of the disclosure will become better apparent from the description of some preferred but not exclusive embodiments of an apparatus for manufacturing panels made of foamed plastic material according to the present disclosure, illustrated by way of non-limiting example in the accompanying drawings, wherein:

FIG. 1 is a side elevation view of an apparatus according to the disclosure; and

FIG. 2 is a top view of the apparatus of FIG. 1.

### DETAILED DESCRIPTION OF THE DRAWINGS

In the exemplary embodiments that follow, individual characteristics, given in relation to specific examples, may actually be interchanged with other different characteristics that exist in other exemplary embodiments.

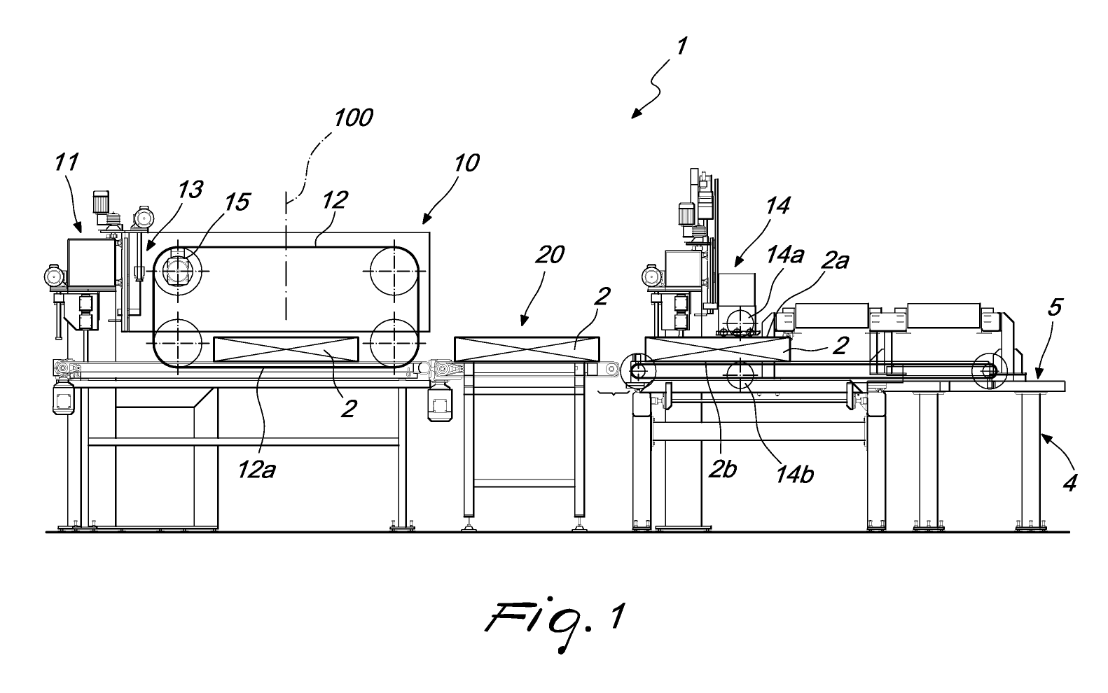

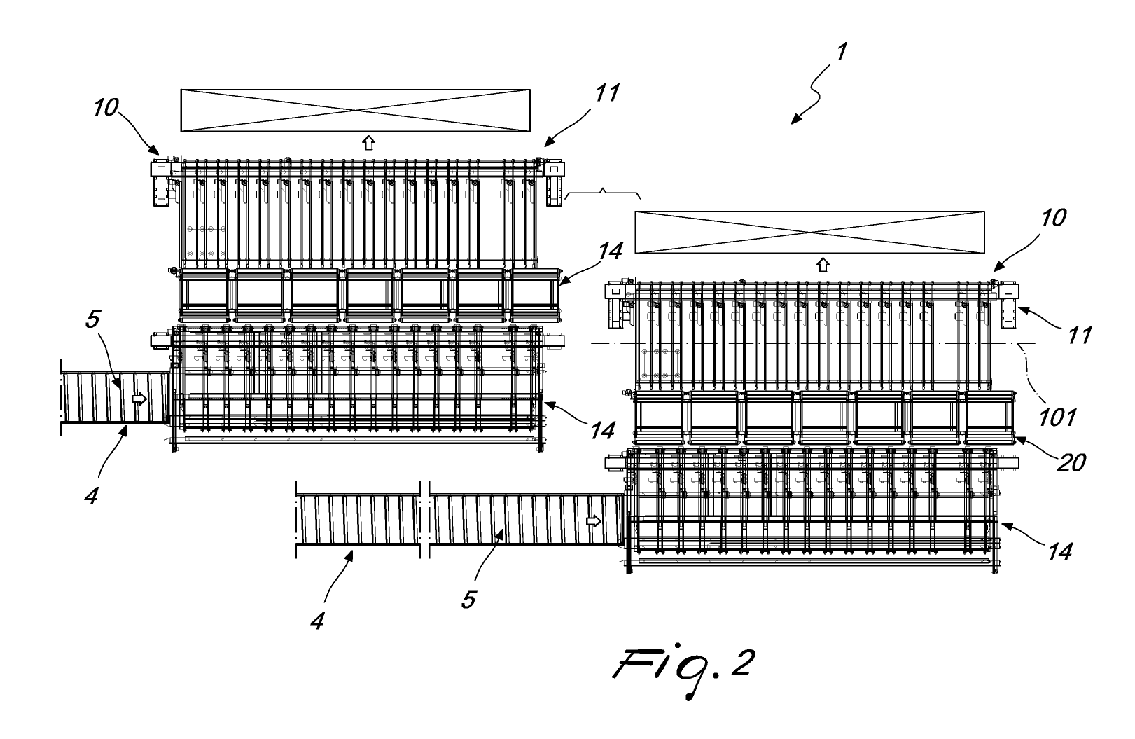

With reference to FIGS. 1 and 2, the present disclosure relates to an apparatus, designated generally by the reference numeral 1, for the manufacture of panels 3 made of foamed plastic material.

The apparatus 1 comprises a supporting framework 4 for a device 5 for feeding a sheet-like element 2 to be cut to a cutting station 10 and a device for unloading the sheet-like element 2 cut into panels 3 made of foamed plastic material from the cutting station 10.

The cutting station 10 comprises a supporting structure 11 for at least one cutting wire 12, which forms, along its extension, a cutting portion 12a that is designed to make contact with the sheet-like element 2 to be cut.

The apparatus 1 is further provided with means 13 for the relative movement of the cutting portion 12a with respect to the sheet-like element 2 to be cut.

The apparatus 1 comprises, upstream of the cutting station 10, an incision station 14 provided with at least one first incision blade 14a, which is adapted to provide, at at least one face of the sheet-like element 2 to be cut, a respective incision at the region designed to be contacted by the cutting portion 12a of the cutting wire 12.

According to the present disclosure, the apparatus 1 has, substantially at a cutting station 10, a device for picking up the dust generated as a consequence of the cutting of the sheet-like element 2.

Specifically, the pickup device is associated with a device for sending the dust to a foaming apparatus.

The forming apparatus, in particular, is designed to produce the sheet-like elements 2 to be cut.

The pickup device can be constituted by a suction device provided with at least one dust intake arranged at each cutting portion 12a.

Advantageously, the apparatus 1 comprises, at the incision station 14, at least one first incision blade 14a that is adapted to provide, at a first face 2a of the sheet-like element 2 to be cut, a respective incision at the region designed to be contacted by the cutting portion 12a and at least one second incision blade 14b that is adapted to provide, at the second face 2b of the sheet-like element 2 to be cut, a respective incision at the region designed to be contacted by the cutting portion 12a.

The incision station 14 is adapted to remove, at the region designed to be contacted by the cutting portion 12a, portions of any covering sheets (for example made of paper or aluminum) of the sheet-like element 2.

Advantageously, the relative movement means 13 are adapted to move the cutting portion 12a with respect to the sheet-like element 2 to be cut at least along a first movement direction 100 that is substantially perpendicular to the plane of arrangement of the sheet-like element 2 to be cut.

With particular reference to FIGS. 1 and 2, according to a preferred embodiment, the relative movement means 13 are adapted to move the cutting portion 12a with respect to the sheet-like element 2 to be cut at least along a second movement direction 101 that has at least one component that is parallel to the plane of arrangement of the sheet-like element 2 to be cut.

In particular, it is possible to control the relative movement of the cutting portion 12a with respect to the sheet-like element 2 so as to provide simultaneously both the cutting and the profile shaping of the panels 3.

Conveniently, the cutting station 10 is provided with a device 15 for moving the cutting wire 12 along the respective longitudinal extension.

Advantageously, the apparatus 1 comprises, upstream of the cutting station 10, a station 20 for temporary storage of the panels to be fed to the cutting station 10.

Furthermore, the apparatus 1 may have two cutting stations 10 arranged in parallel, so as to be able to operate the apparatus continuously even if it is necessary to perform interventions or maintenance on the individual cutting station 10.

With particular reference to the embodiment shown in the figures, the cutting wire 12 can be mounted in a fixed position on the supporting framework 4 and the sheet-like element 2 can be movable in order to contact, with its front edge, the cutting portion 12a of the cutting wire 12.

Advantageously, each cutting station 10 is provided with at least two cutting wires 12.

The movement means 13 are adapted to control independently the movement of each cutting wire 12.

In this manner it is possible to increase cutting speed and precision and also to set different strokes and levels of the cutting wire 12 as a function of the shape of the surface of the sheet-like element 2 that is directed upward.

Conveniently, each cutting wire 12 can be associated with a wire locking device in order to facilitate assembly operations.

Advantageously, each incision station 14 is provided with at least two first incision blades 14a and at least two second incision blades 14b.

Conveniently, independent devices are provided for moving each one of said at least two first incision blades 14a.

In this manner it is possible to increase cutting speed and precision and to set different levels and strokes of the first (and optionally second) incision blades 14a and 14b as a function of the shape of the surface of the sheet-like element 2.

This solution allows to perform cuts with planar longitudinal edges, significantly limiting the quantity of removed material thanks to the extremely low thickness of the wire with respect to the thickness of the blades of traditional cutting units.

Furthermore, the cutting station 10, being preceded by the incision station 14, which is adapted to remove from the cutting region any covering sheets (for example made of paper or aluminum) arranged on the faces of the sheet-like element 2, acts exclusively on the foamed material and accordingly the dust generated by cutting can be aspirated and sent to the foaming apparatus without any treatment or intervention.

All the characteristics of the disclosure indicated above as advantageous, convenient and the like may also be omitted or be replaced with equivalents.

The disclosure thus conceived is susceptible of numerous modifications and variations.

In practice it has been found that the disclosure has achieved the intended advantages in all of its embodiments.

In particular, by virtue of the use of cutting wires the quantity of removed material has been reduced significantly.

In practice, the materials used, as well as the contingent shapes and dimensions, may be any according to the requirements.

All the details may furthermore be replaced with other technically equivalent elements.

The disclosures in Italian Patent Application No. 102015000077563 (UB2015A005981) from which this application claims priority are incorporated herein by reference.

1-9. (canceled)

10. An apparatus for manufacturing panels made of foamed plastic material, comprising a supporting framework for a device for feeding a sheet-like element to be cut to at least one cutting station and a device for unloading the sheet-like element cut into panels made of foamed plastic material from said cutting station, said at least one cutting station comprising a supporting structure for at least one cutting wire that forms, along its own extension, a cutting portion configured to contact said sheet-like element to be cut, means being provided for the relative motion of said cutting portion with respect to said sheet-like element to be cut, there being also, upstream of each cutting station, an incision station having at least one first incision blade adapted to provide, at at least one face of said sheet-like element to be cut, a respective incision at the region configured to be contacted by said cutting portion of said cutting wire, and further comprising, substantially at said cutting station, a device for picking up the dust generated as a consequence of the cutting of said sheet-like element.

11. The apparatus according to claim 10, wherein said pick-up device is associated with a device for sending said dust to a foaming apparatus.

12. The apparatus according to claim 10, further comprising, upstream of said cutting station, a station for temporary storage of the sheet-like elements to be fed to said cutting station.

13. The apparatus according to claim 10, wherein said cutting station has a device for moving the cutting wire along the respective longitudinal extension.

14. The apparatus according to claim 10, wherein said means for the relative motion of said cutting portion are adapted to move said cutting portion with respect to said sheet-like element to be cut at least along a first movement direction that is substantially perpendicular to a plane of arrangement of said sheet-like element to be cut.

15. The apparatus according to claim 14, wherein said means for the relative motion of said cutting portion are adapted to move said cutting portion with respect to said sheet-like element to be cut at least along a second movement direction that has at least one component that is parallel to the plane of arrangement of said sheet-like element to be cut.

16. The apparatus according to claim 10, further comprising, for each cutting station, at least two cutting wires, said means for the relative motion of said cutting portion being adapted to actuate independently the movement of the cutting portions of each cutting wire.

17. The apparatus according to claim 10, further comprising, at said incision station, at least one first incision blade adapted to provide, at a first face of said sheet-like element to be cut, a respective incision at a region intended to be contacted by said cutting portion and at least one second incision blade adapted to provide, at a second face of said sheet-like element to be cut, a respective incision at the region intended to be contacted by said cutting portion.

18. The apparatus according to claim 10, further comprising, at said incision station, at least two first incision blades and at least two second incision blades, independent means for moving each one of said at least two first incision blades being provided.
